(19) United States
(12) Patent Application Publication
(10) Pub. No.: US 2006/0114930 A1
(43) Pub. Date: Jun. 1, 2006

(54) In-band control of indicators to identify devices distributed on the same domain

(75) Inventors: Gregg S. Lucas, Tucson, AZ (US); Robert A. Kubo, Tucson, AZ (US); Michael A. Curnalia, Tucson, AZ (US); Aaron R. Cox, Tucson, AZ (US); Matthew D. Bomhoff, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines (IBM) Corporation, Armonk, NY (US)

(21) Appl. No.: 10/991,204

(22) Filed: Nov. 17, 2004

(51) Int. Cl. H04J 3/22

(52) U.S. Cl. 370/465

(57) ABSTRACT

Systems, methods and a computer program product are provided to permit the identification of all of the devices of a specified domain in a multi-domain environment. All communication among the domain devices is in-band having the advantage that no additional cabling is required. A control center between host devices and the domains receives an in-band command from an initiating device in a specified domain, the command being transmitted in response to the activation of a triggering device on the initiating device. Upon receipt of the command, the control center broadcasts an in-band command to each of the other devices in the domain directing the other devices to activate an indicator on each of the other devices. With the indicators on the devices in the specified domain activated, an administrator is able to identify those devices and thus focus his search for the faulty device only on those devices within the domain.

### TECHNICAL FIELD

The present invention relates generally to networks of devices distributed across multiple domains and, in particular, to identifying which devices in a multi-domain environment are attached to a particular domain.

### BACKGROUND ART

Large, enterprise-scale computing facilities include one or more host devices to which are attached several (or many) data storage devices. The IBM® TotalStorage® DS6000 storage server is an example of one such device. The DS6000 provides modular storage with distributed enclosure racks which may be easily installed and subsequently relocated by a customer. Enclosures are mounted in the racks to provide an efficient and standardized method of physically organizing the various components. Additionally, the use of rack mounted enclosures allows the customer to place the components in the racks and arrange them in the computing facility in a flexible manner. Each server enclosure may be configured into two (or more) clusters sharing up to 16 disk drives. The enclosures are typically grouped into domains and each domain may include several networks. In a fibre channel environment, each fibre channel network may include up to 126 disk drives. Typically, communications (data and related commands) between host devices and the domains are routed through a control center which may perform various functions, such as RAID control.

The flexibility of a user-configured, rack mounted facility can eventually result in increasing complexity. As a computing facility is upgraded, new devices may be added, existing devices may be moved and domains and networks may be reconfigured through re-cabling. Thus, as a facility grows, enclosures which are in the same domain may no longer be adjacent to each other, in the same rack or even near each other. Thus, there may be multiple enclosures with identical appearance in the same rack but attached to different domains. When a disk drive or other component fails, the facility administrator may be able to identify the domain in which the failed component exists but may not be able to determine which enclosure houses the failed component.

Consequently, a need exists for a means to easily identify all of the devices in a particular domain.

### SUMMARY OF THE INVENTION

The present invention provides systems, methods and a computer program product to permit the identification of all of the devices of a specified domain in a multi-domain environment. Moreover, all communication among the domain devices is in-band having the advantage that no additional cabling is required.

The present invention may be incorporated into the control center through which host/domain communications are routed or may be incorporated into any other dedicated or multi-purpose unit or units to which the domains are attached. In operation, the control center receives an in-band command from an initiating device in a specified domain, the command being transmitted in response to the activation of a triggering device on the initiating device. Upon receipt of the command, the control center broadcasts an in-band command to each of the other devices in the domain directing the other devices to activate an indicator on each of the other devices. With the indicators on the devices in the specified domain activated, the administrator is able to identify those devices and thus focus his search for the faulty device only on those devices within the domain.

Optionally, the control center may receive another in-band command from each other device indicating that the respective indicator has been activated. In response, the control center may then transmit a last command to the initiating device directing the initiating device to activate its indicator.

Also optionally, the indicator of the initiating device may be activated in response to activation of the triggering device. Then, upon receipt of the last command from the control center, the indicator may change states, such as from blinking to on.

### BRIEF DESCRIPTION OF THE DRAWINGS

FIG. 1 is a block diagram of two multi-network domains in which the present invention may be implemented;

FIG. 2 is a block diagram of a control center of the present invention;

FIG. 3 is a block diagram of a domain device of the present invention;

FIGS. 4A-4G schematically illustrate a process of the present invention; and

FIG. 5 is a flow chart of a method of the present invention.

### DETAILED DESCRIPTION OF THE PREFERRED EMBODIMENT

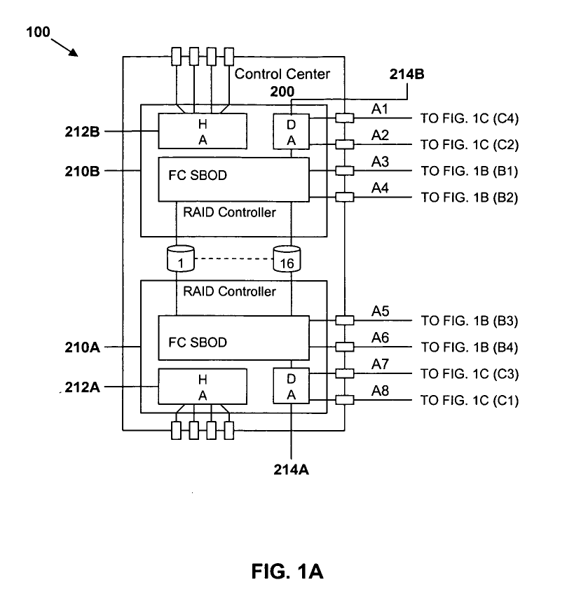

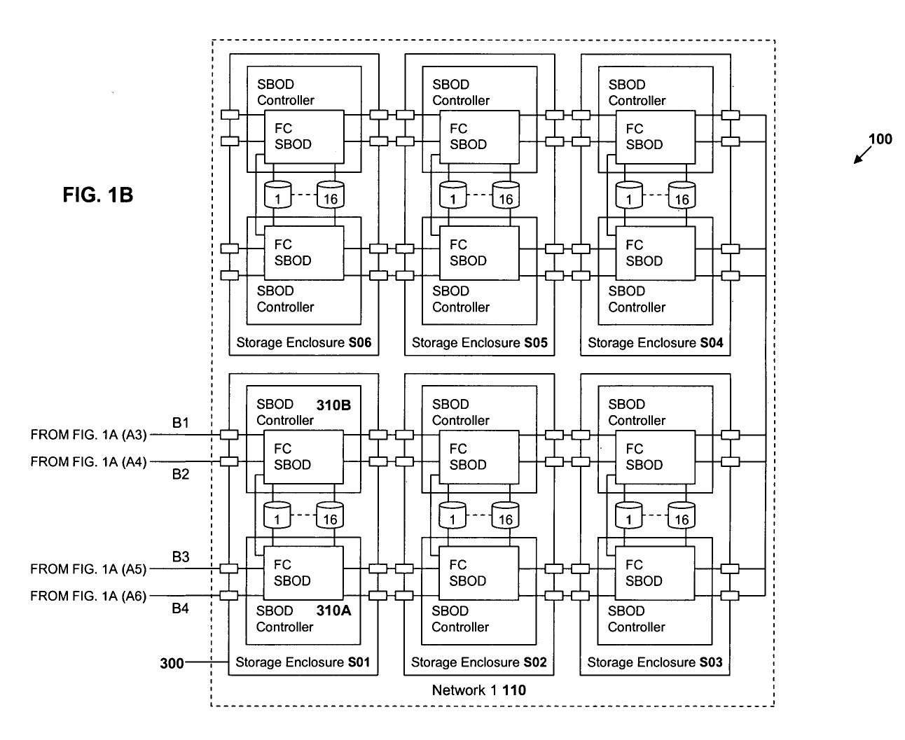

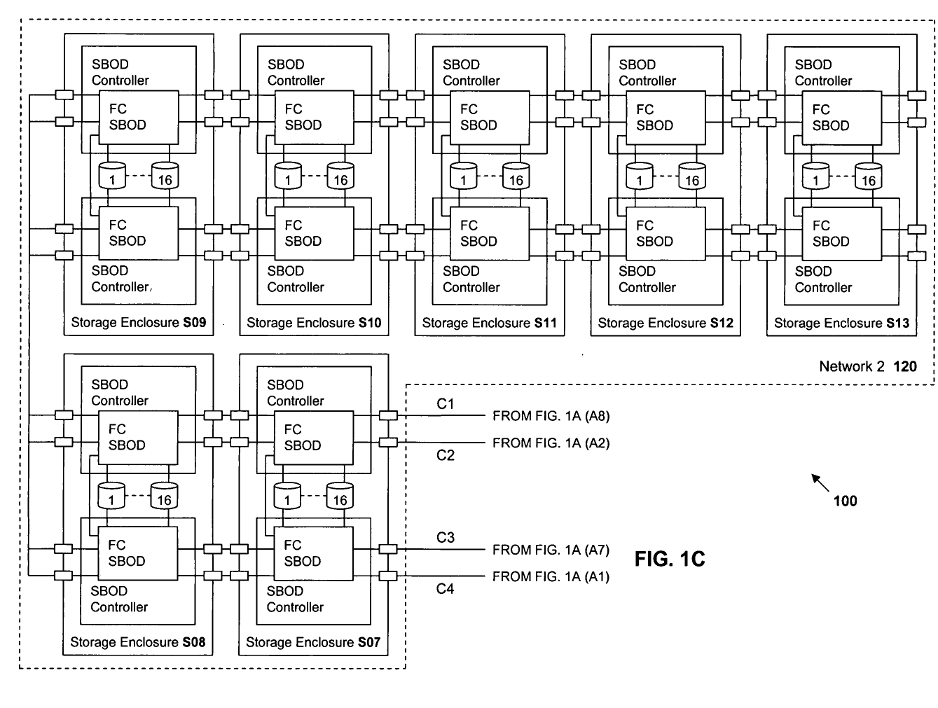

FIG. 1 is a block diagram of an exemplary two-network domain 100 in which the present invention may be implemented. The domain 100 in the FIG. includes a control center 200 and two exemplary networks 110 and 120. Each network includes a plurality of storage enclosures, such as enclosure S01 300 in the first network 110. In FIG. 1, the control center 200 and storage enclosures 300 (also referred to herein as “devices”) each comprise two clusters in a known configuration. A first cluster 210A in the control center 200 is interconnected with a first cluster in each of the storage enclosures in both networks 110 and 120, such as a first cluster 310A of enclosure S01 of the first network 110, and a second cluster 210B in the control center is interconnected with a second cluster in each of the storage enclosures in both networks 110 and 120, such as a second cluster 310B of enclosure S01 of the first network 110. The storage enclosures in the first network 110 may be daisy chained using fibre channel interconnections; the storage enclosures in the second network 120 may be similarly daisy chained using fibre channel interconnections. The configuration of FIG. 1 is illustrative only; other configurations, such as with more networks, other types of devices or with copper cable interconnections, are within the scope of the present invention. Host devices (not shown) attach to the control center 200 through host adapters 212A and 212B and the first and second networks 110 and 120 attach to the control center 200 through device adapters 214A and 214B.

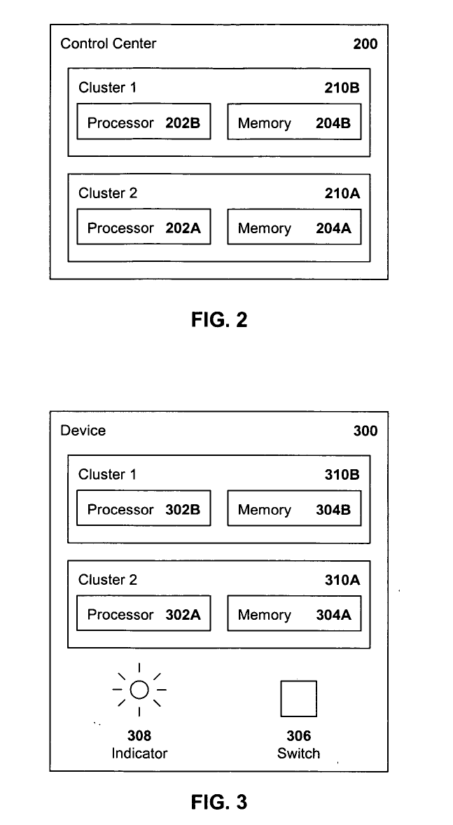

FIG. 2 is a block diagram of the dual-cluster control center 200 of the present invention. In addition to the components previously mentioned, each cluster 210A, 210B of the control center 200 includes a controller or processor 202A, 202B and a memory 204A, 204B. The processor executes instructions stored in the memory 204A, 204B for the control of the process of the present invention.

FIG. 3 is a block diagram of one of the dual-cluster storage enclosures 300 of the present invention. In addition to the components previously mentioned, each cluster 310A, 310B of the device 300 includes a controller or processor 302A, 302B and a memory 304A, 304B. The processor 302A, 302B executes instructions stored in the memory 304A, 304B for the control of the process of the present invention. The enclosure 300 further includes a triggering device 306 and an indicator 308. The triggering device 306 is preferably an administrator-activated switch and the indicator 308 is preferably a visual indicator, such as a light.

All communications between the control center 200 and the devices in each network 110 and 120 occur over the existing, in-band I/O interconnections maintained for the transfer of primary data (such as customer data read from disk drives and transferred to host devices or from host devices to be written to disk drives) and related commands (read, write, etc.). No additional, out-of-band cabling or interconnections are necessary.

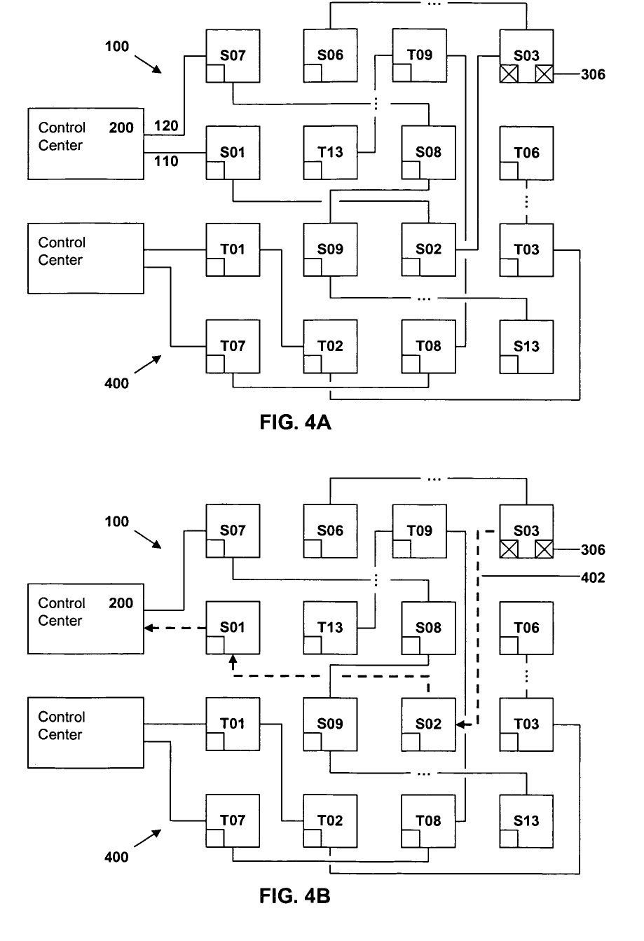

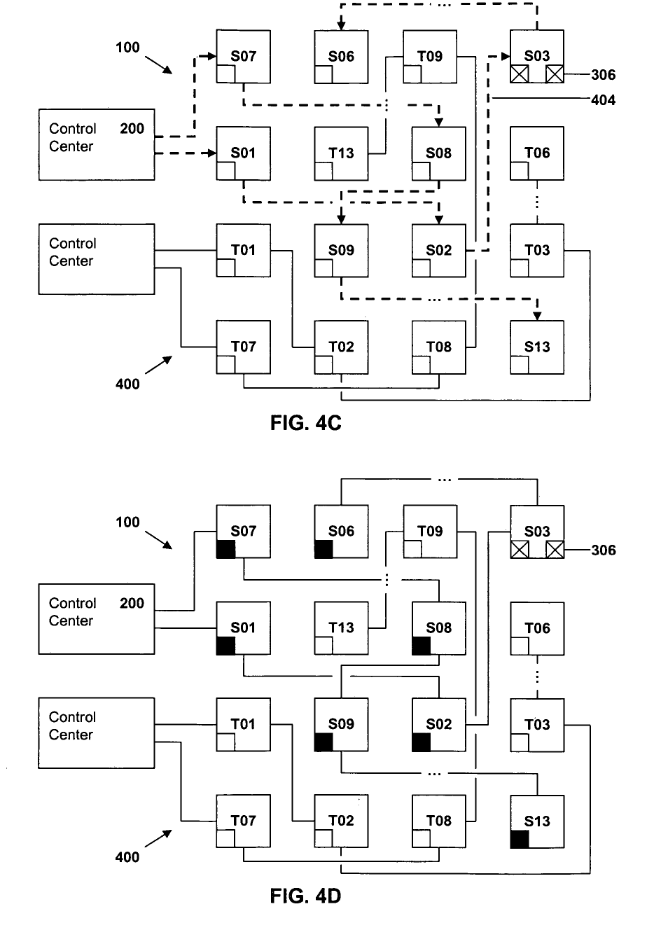

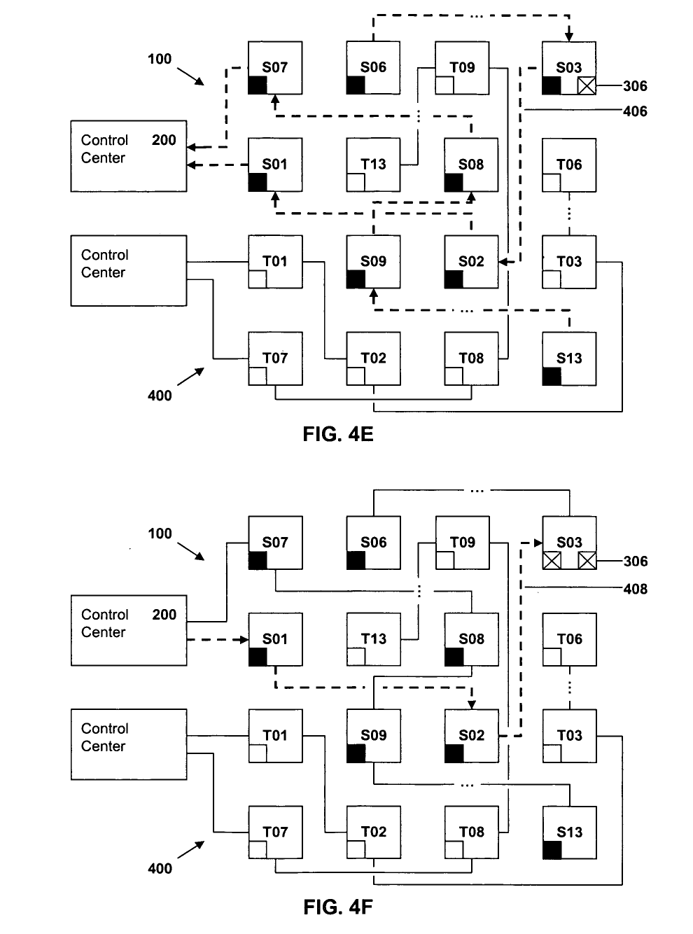

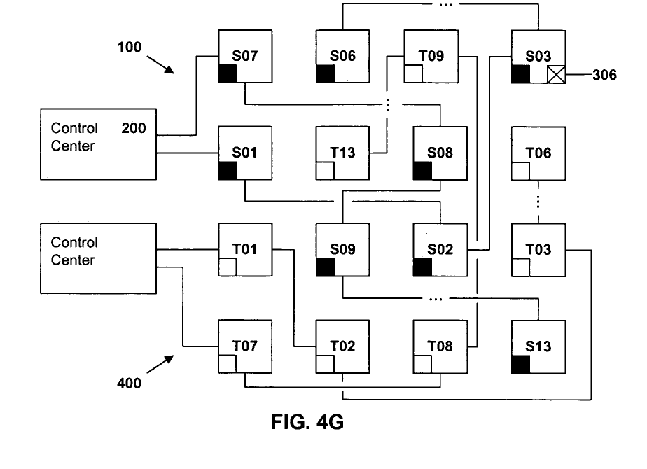

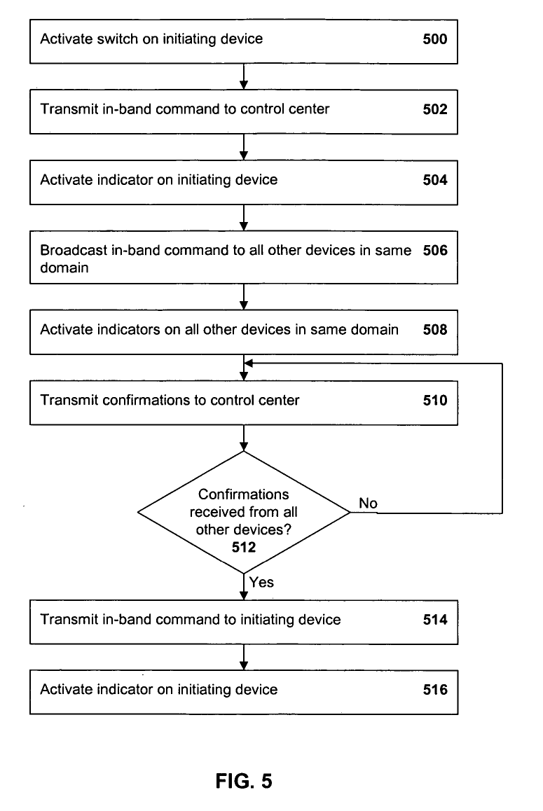

Referring to the schematic illustrations of FIGS. 4A-4G and the flowchart of FIG. 5, the facility administrator may be notified that a disk drive in one of the storage enclosures in the first network 110 is faulty. If the enclosures are neatly separated physically in the two domains, it may be relatively easy for the administrator to identify all of the devices S01-S013 in the first domain 100 simply because of their close physical proximity. However, if the domain 100 has been upgraded, or the enclosures rearranged and/or re-cabled, the enclosures may no longer be adjacent to each other and, especially if the facility is large with many domains and many enclosures, it may be difficult to identify all of the devices in any one domain, as illustrated in FIG. 4A (in which a second two-network domain 400 with an attached control center is shown). Therefore, the administrator goes to an enclosure, such as S03 in FIG. 4A, known to be in the first domain 100 and presses the switch 306 on the enclosure (step 500). Preferably, an enclosure service management process receives a resulting signal and, in response, transmits an in-band command 402 to the control center 200 (step 502; FIG. 4B). In one embodiment, the indicator 308 on the initiating enclosure S03 is activated (step 504). For example, if the indicator 308 is a light, it may be fully illuminated when activated or may instead begin blinking when activated.

Upon receipt of the command 402 from the initiating enclosure S03, the control center 200 broadcasts commands 404 to the other enclosures in the domain 100: S01, S02 and S04-S06 in the first network 110 and S07-S13 in the second network 120 (step 506; FIG. 4C). In response, the indicators on the other enclosures S01, S02 and S04-S13 are activated (step 508; FIG. 4D). If the indicators are lights, they may fully illuminate. At this point, the indicators on all of the enclosures S01-S13 in the domain 100 are activated and the administrator may easily identify them.

Optionally, each of the other enclosures S01, S02 and S04-S13 in the domain 100 may send a status 406 back to the control center 200 verifying that the respective indicator has been activated (steps 510, 512; FIG. 4E). The control center 200 may poll the enclosures and, if not all of the other enclosures S01, S02 and S04-S13 respond with the verification command, an error condition is indicated. If the indicator 308 on the initiating enclosure S03 has not yet been activated or has been activated in a different state (such as by blinking) than the manner in which the indicators have been activated on the other enclosures S01, S02 and S04-S13 (such as fully illuminated), the control center 200 may then transmit another command 408 to the initiating enclosure S03 in response to receiving verification from all of the other enclosures S01, S02 and S04-S13 (step 514; FIG. 4F). In response to this command, the indicator 308 on the initiating enclosure S03 may change its state, such as from off to being fully illuminated or from blinking to fully illuminated (step 516; FIG. 4G).

It is important to note that while the present invention has been described in the context of a fully functioning data processing system, those of ordinary skill in the art will appreciated that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for managing global metadata or a method for deploying computing infrastructure comprising integrating computer readable code into a computing system for managing global metadata.

What is claimed is:

1. A control center for a domain, the control center comprising:
a plurality of device adapters interconnectable to a plurality of devices for the in-band exchange of primary data, the devices arrayed in a domain;
means for receiving a first in-band command transmitted from an initiating device in the domain in response to an activation of a triggering device on the initiating device; and
means for broadcasting a second in-band command to each of the other devices in the domain directing the other devices to activate an indicator to a first state.

2. The control center of claim 1, further comprising:
means for receiving a third in-band command from each of the other devices indicating that the indicator has been activated to the first state; and
means for transmitting a fourth in-band command to the initiating device after the third command has been received from all other devices in the domain, the fourth in-band command directing the initiating device to activate the indicator to the first state.

3. The control center of claim 2, wherein the indicator on the initiating device is in a second state in response to the activation of the triggering device and the fourth in-band command comprises a command directing the initiating device to change the state of the indicator from the second state to the first state.

4. The control center of claim 1, wherein the indicator on the initiating device is in a second state in response to the activation of the triggering device.

5. The control center of claim 4, wherein the second state of the indicator on the initiating device is the same as the first state of the indicators on the other devices.

6. The control center of claim 4, wherein the second state of the indicator on the initiating device is different from the first state of the indicators on the other devices in the domain, the control center further comprising:
means for receiving a third in-band command from each of the other devices in the domain indicating that the indicator has been activated to the first state; and
means for transmitting a fourth in-band command to the initiating device after the third command has been received from all other devices in the domain, the fourth in-band command directing the initiating device to change the indicator to the first state.

7. The control center of claim 1, wherein the plurality of devices to which the device adapters are interconnectable comprise a plurality of storage controllers.

8. The control center of claim 7, wherein the device adapters are interconnectable to the storage controllers through fibre channel links.

9. A method for identifying devices in one of a plurality of domains, the devices in each domain interconnected for in-band exchange of primary data, the method comprising:
receiving a first in-band command from an initiating device in a first domain in response to an activation of a triggering device on the first initiating device; and
broadcasting a second in-band command to all other devices in the first domain directing the other devices to activate an indicator to a first state.

10. The method of claim 9, further comprising:
receiving a third in-band command from each of the other devices indicating of the first domain that the indicator has been activated to the first state; and
transmitting a fourth in-band command to the initiating device after the third command has been received from all other devices in the first domain, the fourth in-band command directing the initiating device to activate the indicator to the first state.

11. The method of claim 10, wherein the indicator on the initiating device is in a second state in response to the activation of the triggering device and the fourth in-band command comprises a command directing the initiating device to change the state of the indicator from the second state to the first state.

12. The method of claim 9, wherein the indicator on the initiating device is in a second state in response to the activation of the triggering device.

13. The method of claim 12, wherein the second state of the indicator on the initiating device is the same as the first state of the indicators on the other devices in the first domain.

14. The method of claim 12, wherein the second state of the indicator on the initiating device is different from the first state of the indicators on the other devices in the first domain, the method further comprising:
receiving a third in-band command from each of the other devices in the first domain indicating that the indicator has been activated to the first state; and
transmitting a fourth in-band command to the initiating device after the third command has been received from all other devices in the first domain, the fourth in-band command directing the initiating device to change the indicator to the first state.

15. The method of claim 9, wherein the plurality of devices to which the device adapters are interconnectable comprise a plurality of storage controllers.

16. The method of claim 15, wherein the device adapters are interconnectable to the storage controllers through fibre channel links.

17. A system for identifying devices in one of a plurality of domains, comprising:
a plurality of control centers, each associated with a domain and each interconnectable with one or more host devices;
a plurality of domains, each interconnected with an associated control centers for the in-band exchange of primary data, each domain comprising a plurality of devices;
a first of the plurality of devices in a first domain, comprising:
an indicator;
a triggering means; and
means for transmitting a first in-band command in response to an activation of the triggering device;
a control center associated with the first domain comprising:
means for receiving the first in-band command; and
means for broadcasting, in response to receipt of the first in-band command, a second in-band command to each of the other devices in the first domain directing the other devices to activate their respective indicators; and
each of the other devices in the first domain, comprising:
an indicator; and
means for activating the indicator on each other device in the first domain to a first state in response to receipt of the second in-band command.

18. The system of claim 17, wherein:
each of the other devices in the first domain further comprise means for transmitting a third in-band command to the first control center confirming the activation of the indicator on each other device in the first domain to the first state;
the first control center further comprising means for transmitting a fourth in-band ccommand to the first device in response to receipt of the third in-band command; and
the first device further comprising means for activating the indicator on the first device to the first state in response to receipt of the fourth in-band command.

19. The system of claim 18, the first device further comprising means for activating the indicator on the first device to a second state in response to the activation of the triggering device.

20. The system of claim 19, wherein:
each indicator is a light;
an indicator in the first state is on; and
an indicator in the second state is blinking.

21. The system of claim 19, wherein the first state is the same as the second state.

22. The system of claim 19, wherein the first state is different from the second state.

23. The system of claim 17, wherein the plurality of devices comprise a plurality of storage controllers.

24. A method for identifying devices in one of a plurality of domains, comprising:
activating a triggering means associated with a first of a plurality of devices in a first domain in a domain, the domain interconnected with a control center for the in-band exchange of primary data;
transmitting a first in-band command from the first device to the control center in response to the activation of the triggering device;
in response to receipt of the first in-band command, broadcasting a second in-band command from the control center to each of the other devices in the first domain directing the other devices to activate respective indicators; and
activating the indicator on each other device to a first state in response to receipt of the second in-band command.

25. The method of claim 24, further comprising:
transmitting from each of the other devices in the first domain a third in-band command to the control center confirming the activation of the indicator on each other device to the first state;
transmitting from the control center a fourth in-band command to the first device in response to receipt of the third in-band command; and
activating the indicator on the first device to the first state in response to receipt of the fourth in-band command.

26. The method of claim 25, further comprising activating the indicator on the first device to a second state in response to the activation of the triggering device.

27. The method of claim 26, wherein:
the indicator is a light;
an indicator in the first state is on; and
an indicator in the second state is blinking.

28. The method of claim 26, wherein the first state is the same as the second state.

29. The method of claim 26, wherein the first state is different from the second state.

30. The method of claim 24, wherein the plurality of devices comprise a plurality of storage controllers.

31. A computer program product of a computer readable medium usable with a programmable computer, the computer program product having computer-readable code embodied therein for identifying devices in one of a plurality of domains, the devices in each domain interconnected for in-band exchange of primary data, the computer-readable code comprising instructions for:
receiving a first in-band command from an initiating device in a first domain in response to an activation of a triggering device on the first initiating device; and
broadcasting a second in-band command to all other devices in the first domain directing the other devices to activate an indicator to a first state.

32. The computer program product of claim 31, the computer-readable code further comprising instructions for:
receiving a third in-band command from each of the other devices indicating that the indicator has been activated to the first state; and
transmitting a fourth in-band command to the initiating device after the third command has been received from all other devices, the fourth in-band command directing the initiating device to activate the indicator to the first state.

33. The computer program product of claim 32, wherein the indicator on the initiating device is in a second state in response to the activation of the triggering device and the fourth in-band command comprises a command directing the initiating device to change the state of the indicator from the second state to the first state.

34. The computer program product of claim 31, wherein the indicator on the initiating device is in a second state in response to the activation of the triggering device.

35. The computer program product of claim 34, wherein the second state of the indicator on the initiating device is the same as the first state of the indicators on the other devices.

36. The computer program product of claim 34, wherein the second state of the indicator on the initiating device is different from the first state of the indicators on the other devices, the computer-readable code further comprising instructions for:
receiving a third in-band command from each of the other devices in the first domain indicating that the indicator has been activated to the first state; and
transmitting a fourth in-band command to the initiating device after the third command has been received from all other devices in the first domain, the fourth in-band command directing the initiating device to change the indicator to the first state.

37. The computer program product of claim 31, wherein the plurality of devices to which the device adapters are interconnectable comprise a plurality of storage controllers.

38. A method for deploying computing infrastructure, comprising integrating computer readable code into a computing system, wherein the code, in combination with the computing system, is capable of performing the following:
receiving a first in-band command from an initiating device in a first domain in response to an activation of a triggering device on the first initiating device; and
broadcasting a second in-band command to all other devices in the first domain directing the other devices to activate an indicator to a first state.

39. The method of claim 38, wherein the code, in combination with the computing system, is further capable of performing the following:
receiving a third in-band command from each of the other devices in the first domain indicating that the indicator has been activated to the first state; and
transmitting a fourth in-band command to the initiating device after the third command has been received from all other devices in the first domain, the fourth in-band command directing the initiating device to activate the indicator to the first state.

40. The method of claim 39, wherein the indicator on the initiating device is in a second state in response to the activation of the triggering device and the fourth in-band command comprises a command directing the initiating device to change the state of the indicator from the second state to the first state.

41. The method of claim 38, wherein the indicator on the initiating device is in a second state in response to the activation of the triggering device.

42. The method of claim 41, wherein the second state of the indicator on the initiating device is the same as the first state of the indicators on the other devices in the first domain.

43. The method of claim 41, wherein the second state of the indicator on the initiating device is different from the first state of the indicators on the other devices in the first domain and wherein the code, in combination with the computing system, is further capable of performing the following:
receiving a third in-band command from each of the other devices in the first domain indicating that the indicator has been activated to the first state; and
transmitting a fourth in-band command to the initiating device after the third command has been received from all other devices in the first domain, the fourth in-band command directing the initiating device to change the indicator to the first state.

44. The method of claim 38, wherein the plurality of devices to which the device adapters are interconnectable comprise a plurality of storage controllers.

45. The method of claim 44, wherein the device adapters are interconnectable to the storage controllers through fibre channel links.
